(19) United States
(12) Patent Application Publication
(10) Pub. No.: US 2025/0088886 A1
(43) Pub. Date: Mar. 13, 2025

(54) GAPS FOR SI READING IN MULTI-USIM

(71) Applicant: TELEFONAKTIEBOLAGET LM ERICSSON (PUBL), STOCKHOLM (SE)

(72) Inventors: Zhixun Tang, TÄBY (SE); Muhammad Ali Kazmi, RESTON, VA (US); Lian Araujo, KAWASAKI (SE)

(21) Appl. No.: 18/727,992

(22) PCT Filed: Jan. 9, 2023
(86) PCT No.: PCT/IB2023/050174

§ 371 Date: Jul. 10, 2024

(30) Foreign Application Priority Data
Jan. 10, 2022 (WO) PCT/CN2022/071141

(51) Int. Cl. H04W 24/10; H04L 5/00; H04W 72/231

(52) U.S. Cl. CPC H04W 24/10; H04L 5/0051; H04W 72/231

(57) ABSTRACT

Systems and method are disclosed for enabling a User Equipment (UE) that is served by a first cell in a first network to be configured with measurement gaps for acquiring system information (SI) of a second cell in a second network. In one embodiment, a method performed by a UE for acquiring SI of a second cell in a second network using a measurement gap(s) on a first cell in a first network comprises determining candidate SI positions on the second cell and indicating, to a network node, information which identifies the candidate SI positions on the second cell. Embodiments of a UE and further embodiments of methods of operation thereof are also disclosed. Embodiments of a first network node and methods of operation thereof are also disclosed.

### RELATED APPLICATIONS

This application claims the benefit of international patent application serial number PCT/CN2022/071141, filed Jan. 10, 2022, the disclosure of which is hereby incorporated herein by reference in its entirety.

### TECHNICAL FIELD

The present disclosure relates to acquiring system information in a cellular communications system.

### BACKGROUND

### Multi-USIM Operation

A multi-Universal Subscriber Identity Module (USIM) (i.e., a MUSIM) User Equipment (UE) has two or more subscriptions for different services (e.g., use one individual subscription and one family circle plan). Each USIM or Subscriber Identity Module (SIM) may be associated with one subscription. Different USIMs or SIMs in the UE may be associated with or belong to or registered with the same operator or different operators. In one MUSIM scenario, the UE may be in Radio Resource Control (RRC) idle (i.e., RRC_IDLE) state or inactive (i.e., RRC_INACTIVE) state with respect to all the registered networks. In this case, the UE needs to monitor and receive paging from more than one network. In another MUSIM scenario, the UE may be in RRC idle state or inactive state with respect to one of the registered networks while in RRC connected state with respect to another network. In this case, the UE needs to monitor and receive paging from one network while receiving/transmitting data in another network.

### Acquisition of an SI Message

The system information (SI) consists of master information block (MIB) and one or more system information blocks (SIBs) (e.g., SIB1, SIB2, etc.).

In New Radio (NR), the MIB is transmitted on the Physical Broadcast Channel (PBCH) with Synchronization Signal (SS)/PBCH Measurement Time Configuration (SMTC) periodicity (or SS/PBCH Block (SSB) period). SMTC periodicity is configurable by the network and it is 5, 10, 20, 40, 80, and 160 milliseconds (ms). The example of MIB information is the timing information MIB is transmitted. The example of MIB information is:
the system frame number (SFN)
a part of the SS/PBCH block start position where MIB is transmitted within the SS burst (remaining SSB block index)
SSB block is transmitted in the first half of radio frame or second half of radio frame (half-frame timing))
information of SIB1 scheduling

MIB transmit time interval (TTI) or MIB periodicity is 80 ms. This means the MIB information may change every 80 ms except for SFN. Since SFN changes every 10 ms, the information bits corresponding to SFN changes depending on the transmitted SFN.

Some SIBs may be transmitted periodically, e.g. SIB1. Some SIBs may also be provided on-demand, i.e., upon a request from UE, e.g., based on Random Access Channel (RACH) or RRC, so an additional delay for requesting the on-demand SI may occur prior to receiving the on-demand SI.

For SI message acquisition Physical Downlink Control Channel (PDCCH) monitoring occasion(s) are determined according to searchSpaceOtherSystemInformation. If searchSpaceOtherSystemInformation is set to zero, PDCCH monitoring occasions for SI message reception in SI-window are same as PDCCH monitoring occasions for SIB1 where the mapping between PDCCH monitoring occasions and SSBs is specified in TS 38.213 v17.0.0. If searchSpaceOtherSystemInformation is not set to zero, PDCCH monitoring occasions for SI message are determined based on search space indicated by searchSpaceOtherSystemInformation. PDCCH monitoring occasions for SI message which are not overlapping with uplink symbols (determined according to tdd-UL-DL-ConfigurationCommon) are sequentially numbered from one in the SI window. The [x×N+K]^{th} PDCCH monitoring occasion(s) for SI message in SI-window corresponds to the K^{th} transmitted SSB, where x=0, 1, . . . X−1, K=1, 2, . . . N, N is the number of actual transmitted SSBs determined according to ssb-PositionsInBurst in SIB1 and X is equal to CEIL (number of PDCCH monitoring occasions in SI-window/N). The actual transmitted SSBs are sequentially numbered from one in ascending order of their SSB indexes. The UE assumes that, in the SI window, PDCCH for an SI message is transmitted in at least one PDCCH monitoring occasion corresponding to each transmitted SSB and thus the selection of SSB for the reception SI messages is up to UE implementation

In regard to acquiring an SI message, 3GPP TS 38.331 V16.7.0 states the following:
When acquiring an SI message, the UE shall:
   1>determine the start of the SI-window for the concerned SI message as follows:
      2>if the concerned SI message is configured in the schedulingInfoList:
         3>for the concerned SI message, determine the number n which corresponds to the order of entry in the list of SI messages configured by schedulingInfoList in si-SchedulingInfo in SIB1;
         3>determine the integer value x=(n−1)×w, where w is the si-Window Length;
         3>the SI-window starts at the slot #a, where a=x mod N, in the radio frame for which SFN mod T=FLOOR(x/N), where T is the si-Periodicity of the concerned SI message and N is the number of slots in a radio frame as specified in TS 38.213 [13];
      2>else if the concerned SI message is configured in the posSchedulingInfoList and offsetToSI-Used is not configured:
         3>create a concatenated list of SI messages by appending the posSchedulingInfoList in posSI-SchedulingInfo in SIB1 to schedulingInfoList in si-SchedulingInfo in SIB1;
         3>for the concerned SI message, determine the number n which corresponds to the order of entry in the concatenated list;
         3>determine the integer value x=(n−1)×w, where w is the si-WindowLength;
         3>the SI-window starts at the slot #a, where a=x mod N, in the radio frame for which SFN mod T=FLOOR(x/N), where T is the posSI-Periodicity of the concerned SI message and N is the number of slots in a radio frame as specified in TS 38.213 [13];
      2>else if the concerned SI message is configured by the posSchedulingInfoList and offsetToSI-Used is configured:
         3>determine the number m which corresponds to the number of SI messages with an associated si-Periodicity of 8 radio frames (80 ms), configured by schedulingInfoList in SIB1;
         3>for the concerned SI message, determine the number n which corresponds to the order of entry in the list of SI messages configured by posSchedulingInfoList in SIB1;
         3>determine the integer value x=m×w+(n−1)×w, where w is the si-WindowLength;
         3>the SI-window starts at the slot #a, where a=x mod N, in the radio frame for which SFN mod T=FLOOR(x/N)+8, where T is the posSI-Periodicity of the concerned SI message and N is the number of slots in a radio frame as specified in TS 38.213 [13];
   1>receive the PDCCH containing the scheduling RNTI, i.e. SI-RNTI in the PDCCH monitoring occasion(s) for SI message acquisition, from the start of the SI-window and continue until the end of the SI-window whose absolute length in time is given by si-WindowLength, or until the SI message was received;
   1>if the SI message was not received by the end of the SI-window, repeat reception at the next SI-window occasion for the concerned SI message in the current modification period;
   NOTE 1: The UE is only required to acquire broadcasted SI message if the UE can acquire it without disrupting unicast data reception, i.e. the broadcast and unicast beams are quasi co-located.
   NOTE 2: The UE is not required to monitor PDCCH monitoring occasion(s) corresponding to each transmitted SSB in SI-window.
   NOTE 3: If the concerned SI message was not received in the current modification period, handling of SI message acquisition is left to UE implementation.
   NOTE 4: A UE in RRC_CONNECTED may stop the PDCCH monitoring during the SI window for the concerned SI message when the requested SIB(s) are acquired.
   NOTE 5: A UE capable of NR sidelink communication and configured by upper layers to perform NR sidelink communication on a frequency, may acquire SIB12 from a cell other than current serving cell (for RRC_INACTIVE or RRC_IDLE) or current PCell (for RRC_CONNECTED), if SIB12 of current serving cell (for RRC_INACTIVE or RRC_IDLE) or current PCell (for RRC_CONNECTED) does not provide configuration for NR sidelink communication for the frequency, and if the other cell providing configuration for NR sidelink communication for the frequency meets the S-criteria as defined in TS 38.304 [20] and TS 36.304 [27].
   1>perform the actions for the acquired SI message as specified in sub-clause 5.2.2.4.

### Scheduling of SI Message

The period of SI scheduling (si-Periodicity) can be {rf8, rf16, rf32, rf64, rf128, rf256, rf512} radio frames. For NR, the SI window Length (si-WindowLength) range can be {s5, s10, s20, s40, s80, s160, s320, s640, s1280} slots, for Long Term Evolution (LTE) the SI window Length (si-WindowLength) range can be {ms1, ms2, ms5, ms10, ms15, ms20, ms40} ms.

### DRX Cycle Operation

The UE can be configured with a Discontinuous Reception (DRX) cycle to use in all RRC states (e.g., RRC idle state, RRC inactive state, and RRC connected state) to save UE power consumption and battery life. Examples of lengths of DRX cycles currently used in RRC idle/inactive state are 256 ms, 320 ms, 640 ms, 1.28 seconds(s), 2.56 s, 5.12 s, 10.24 s, etc. Examples of lengths of DRX cycles currently used in RRC connected state may range from 256 ms to 10.24 s. The DRX cycle is configured by the network node and is characterized by the following parameters:
On duration: During the on duration of the DRX cycle, a timer called ‘onDurationTimer’, which is configured by the network node, is running. This timer specifies the number of consecutive control channel subframes (e.g., PDCCH slots) at the beginning of a DRX Cycle. It is also interchangeably called as DRX ON period. It is the duration (e.g., in number of downlink subframes) during which the UE after waking up from DRX may receive control channel (e.g., PDCCH, wake up signal etc.). If the UE successfully decodes the control channel (e.g., PDCCH) during the on duration then the UE starts a drx-inactivity timer (see below) and stays awake until its expiry.
Drx-inactivity timer: It specifies the number of consecutive control channel (e.g., PDCCH,) subframe(s) after the subframe in which a control channel (e.g., PDCCH) indicates an initial uplink (UL) or downlink (DL) user data transmission for this Medium Access Control (MAC) entity. It is also configured by the network node.
DRX active time: This time is the duration during which the UE monitors the control channel (e.g., PDCCH, wake up signals, etc.). In other words, this is the total duration during which the UE is awake. This includes the “on-duration” of the DRX cycle, the time during which the UE is performing continuous reception while the inactivity timer has not expired and the time the UE is performing continuous reception while waiting for a DL retransmission after one Hybrid Automatic Repeat Request (HARQ) round trip time. This means duration over which the drx-inactivity timer is running is called as DRX active time, i.e. no DRX is used by the UE.
DRX inactive time: The time during the DRX cycle other than the active time is called as DRX inactive time, i.e. DRX is used by the UE.

The DRX active time and DRX inactive time are also called as DRX ON and DRX OFF durations of the DRX cycle respectively are shown in FIG. 1. The DRX inactive time may also be called as non-DRX or non-DRX period. The DRX operation with more detailed parameters is illustrated in FIG. 2.

DRX configuration herein may also be an enhanced or extended DRX (eDRX) configuration which applies in RRC_IDLE or RRC_INACTIVE states (only up to 10.24 seconds). In legacy DRX related procedures the UE can be configured with DRX cycle length of up to 10.24 seconds. But UEs supporting extended DRX (eDRX) can be configured with a DRX cycle at least longer than 10.24 seconds and typically much longer than 10.24 seconds, i.e. in order of several seconds to several minutes. The eDRX configuration parameters include an eDRX cycle length, paging window length aka paging time window (PTW) length, etc. Within a PTW of the eDRX, the UE is further configured with one or more legacy DRX cycles.

### Measurement Gaps

A Measurement Gap Pattern (MGP) is used by the UE for performing measurements on cells of the non-serving carriers (e.g., inter-frequency carrier, inter-Radio Access Technology (RAT) carriers, etc.). In NR, measurement gaps are also used for measurements on cells of the serving carrier in some scenarios, e.g. if the measured signals (e.g., SSB) are outside the bandwidth part (BWP) of the serving cell. The UE is scheduled in the serving cell only within the BWP. During a measurement gap, the UE cannot be scheduled for receiving/transmitting signals in the serving cell. A measurement gap pattern is characterized or defined by several parameters: measurement gap length (MGL), measurement gap repetition period (MGRP), measurement gap time offset (MGTO) with respect to reference time (e.g., slot offset with respect to the serving cell's system frame number (SFN) such as SFN=0), measurement gap timing advance (MGTA), etc. An example of a MGP is shown in FIG. 3. As an example, the MGL can be 1.5, 3, 3.5, 4, 5.5, or 6 ms, and the MGRP can be 20, 40, 80 or 160 ms. Such type of MGP is configured by the network node and is also referred to as a network controlled or network configurable MGP. Therefore, the serving base station is fully aware of the timing of each measurement gap within the MGP.

In NR, there are two major categories of MGPs: per-UE measurement gap patterns and per-frequency range (FR) measurement gap patterns. In NR, the spectrum is divided into two frequency ranges namely FR1 and FR2. FR1 is currently defined from 410 Megahertz (MHz) to 7125 MHz. FR2 range is currently defined from 24250 MHz to 52600 MHz. In another example, the FR2 range can be from 24250 MHz to 71000 MHz. The FR2 range is also interchangeably referred to as millimeter wave (mmwave) and corresponding bands in FR2 are referred to as mmwave bands. In the future, more frequency ranges can be specified, e.g. FR3. An example of FR3 is frequency ranging between 7125 MHz and 24250 MHz.

When configured with a per-UE MGP, the UE creates gaps on all the serving cells (e.g., Primary Cell (PCell), Primary Secondary Cell (PSCell), Secondary Cells (SCells), etc.) regardless of their frequency range. The per-UE MGP can be used by the UE for performing measurements on cells of any carrier frequency belonging to any RAT (e.g., 5^{th} Generation (5G) NR, 4^{th} Generation (4G) LTE/LTE-advanced, 3^{rd} Generation (3G) Wideband Code Division Multiple Access (WCDMA)/High Speed Packet Access (HSPA)/Code Division Multiple Access (CDMA) 2000 (CDMA2000), 2^{nd} Generation (2G) Global System for Mobile communications (GSM)) or frequency range (FR). When configured with a per-FR MGP (if UE supports this capability), the UE creates gaps only on the serving cells of the indicated FR whose carriers are to be measured. For example, if the UE is configured with a per-FR1 MGP, then the UE creates measurement gaps only on serving cells (e.g., PCell, PSCell, SCells, etc.) of FR1 while no measurement gaps are created on serving cells on carriers of FR2. The per-FR1 measurement gaps can be used for measurements on cells of only FR1 carriers. Similarly, per-FR2 measurement gaps when configured are only created on FR2 serving cells and can be used for measurements on cells of only FR2 carriers. Support for per FR gaps is a UE capability, i.e. certain UEs may only support per UE gaps according to their capability.

### Measurement Gap for SI Acquisition

The SI acquisition of a cell comprises acquiring or reading or receiving the MIB and/or one or more SIBs (e.g., SIB1, SIB2, etc.) of that cell. The SI of a cell in network #2 can be acquired using an aperiodic gap pattern to fulfill the task of MIB/SIB1 reading. In addition, the SI of a cell in network #2 can also be acquired using legacy gap patterns (e.g., periodic gap pattern), but this may not be efficient. A UE may require multiple attempts to read SI (e.g., MIB/SIB1) when using an aperiodic gap. For efficiency purpose, a legacy gap pattern configured for acquiring the SI (e.g., MIB/SIB1 reading) can be released after successfully decoding the SI (e.g., SIB1 information).

### SUMMARY

Systems and method are disclosed herein for enabling a User Equipment (UE) that is served by a first cell that is controlled or managed by a first network node in a first network to be configured with measurement gaps for acquiring system information (SI) of a second cell in a second network. In one embodiment, a method performed by a UE for acquiring SI of a second cell in a second network using one or more measurement gaps on a first cell in a first network comprises determining candidate SI positions on the second cell and indicating, to a network node, information which identifies the candidate SI positions on the second cell. In this manner, the UE is able to indicate a preference for, or request, measurement gaps that will enable the UE to acquire SI of the second cell in the second network.

In one embodiment, the network node is a network node that controls the first cell in the first network.

In one embodiment, the method further comprises identifying a number, N1, of candidate reference signal (RS) indices, on the second cell in the second network, that meet one or more RS detection conditions, wherein determining the candidate SI positions on the second cell comprises determining the candidate SI positions on the second cell based on the candidate RS indices.

In one embodiment, the information which identifies the candidate SI positions on the second cell comprises information about a preferred number, K1, of measurement gaps on the first cell in the first network, the number, K1, of measurement gaps being associated with the candidate SI positions.

In one embodiment, the method further comprises receiving, from the network node, information that configures the UE with one or more measurement gaps on the first cell in the first network, in accordance with the information indicated to the network node. In one embodiment, the method further comprises acquiring SI for the second cell in the second network using the one or more measurement gaps.

In one embodiment, the one or more RS detection conditions comprise a condition that a received power of a respective RS is greater than a threshold power level. In one embodiment, the threshold is predefined, network configured, or up to UE implementation.

In one embodiment, the one or more RS detection conditions comprise a condition that a number, M1, RS indices that correspond to a number, M1, strongest RSs as measured at the UE are identified as or comprised in the number, N1, of candidate RS indices. In one embodiment, M1 is predefined, network configured, or up to UE implementation.

In one embodiment, determining the candidate SI positions on the second cell based on the candidate RS indices comprises determining the candidate SI positions based on positions of Physical Downlink Control Channel (PDCCH) monitoring occasions for SI acquisition on the second cell that map to the candidate RS indices.

In one embodiment, K1 is function of a relation between distance in time among any two candidate SI positions and a threshold. In one embodiment, K1=N1 if the relation between distance in time among any two candidate SI positions is greater than the threshold and otherwise K1<N1.

In one embodiment, K1=N1. In another embodiment, K1<N1.

In one embodiment, the measurement gaps are aperiodic.

In one embodiment, the method further comprises indicating, to the network node, one or more preferred parameters for the measurement gaps. In one embodiment, the one or more preferred parameters comprise either or both of a preferred measurement gap length and a preferred measurement gap offset.

In one embodiment, the RS indices are Synchronization Signal (SS)/Physical Broadcast Channel (PBCH) block indices.

In another embodiment, a method performed by a UE for acquiring SI of a second cell in a second network using one or more measurement gaps on a first cell in a first network comprises identifying information about a number, N1, of candidate RSs, on a second cell in the second network, that meet one or more RS detection conditions. The method further comprises reporting the information about the candidate RSs to a network node.

In one embodiment, the network node is a network node that controls the first cell in the first network.

In one embodiment, the information about the candidate RSs comprises indices of the candidate RS.

In one embodiment, the method further comprises receiving, from the network node, information that configures the UE with one or more measurement gaps on the first cell in the first network, responsive to reporting the information. In one embodiment, the method further comprises acquiring SI for the second cell in the second network using the one or more measurement gaps.

In one embodiment, the one or more RS detection conditions comprise a condition that a received power of a respective RS is greater than a threshold power level. In one embodiment, the threshold is predefined, network configured, or up to UE implementation.

In one embodiment, the one or more RS detection conditions comprise a condition that a number, M1, of strongest RSs as measured at the UE are identified as or comprised in the number, N1, of candidate RSs. In one embodiment, M1 is predefined, network configured, or up to UE implementation.

Corresponding embodiments of a UE are also disclosed herein. In one embodiment, a UE for acquiring system information of a second cell in a second network using one or more measurement gaps on a first cell in a first network comprises one or more transmitters, one or more receivers, and processing circuitry associated with the one or more transmitters and the one or more receivers. The processing circuitry is configured to cause the UE to determine candidate SI positions on the second cell and indicate, to a network node, information which identifies the candidate SI positions on the second cell.

In another embodiment, a UE for acquiring system information of a second cell in a second network using one or more measurement gaps on a first cell in a first network comprises one or more transmitters, one or more receivers, and processing circuitry associated with the one or more transmitters and the one or more receivers. The processing circuitry is configured to cause the UE to identify information about a number, N1, of candidate RSs on a second cell in the second network, that meet one or more RS detection conditions, and report information about the candidate RSs to a network node.

Embodiments of a method performed by a first network node are also disclosed. In one embodiment, a method performed by a first network node that manages or controls a first cell in a first network for configuring a UE with measurement gaps for acquiring system information of a second cell in a second network comprises determining a number, J1, of measurement gaps that meet at least one signal reception proximity condition, wherein signal reception proximity defines a time gap between any two measurement gaps used for or preferred by the UE for SI acquisition in the second cell and a signal reception proximity condition is met if the time gap is equal to or smaller than a certain threshold. The method further comprises configuring the UE with the number, J1, of measurement gaps.

Corresponding embodiments of a first network node are also disclosed herein. In one embodiment, a first network node that manages or controls a first cell in a first network for configuring a UE with measurement gaps for acquiring system information of a second cell in a second network comprises processing circuitry configured to cause the first network node to determine a number, J1, of measurement gaps that meet at least one signal reception proximity condition, wherein signal reception proximity defines a time gap between any two measurement gaps used for or preferred by the UE for SI acquisition in the second cell and a signal reception proximity condition is met if the time gap is equal to or smaller than a certain threshold. The processing circuitry is further configured to cause the first network node to configure the UE with the number, J1, of measurement gaps.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrate a Discontinuous Reception (DRX) cycle showing ON and OFF durations;

FIG. 2 illustrates a DRX cycle showing different DRX related parameters;

FIG. 3 illustrates an example of a measurement gap pattern in Third Generation Partnership Project (3GPP) New Radio (NR);

FIG. 4 illustrates an example of a cellular communication system in which embodiments of the present disclosure may be implemented;

FIG. 5 is a flow chart that illustrates the operation of UE in accordance with one embodiment of the present disclosure;

FIG. 6 illustrates an example of UE monitoring system information (SI) by control channel (e.g., PDCCH) monitor occasions in an SI window in accordance with an embodiment of the present disclosure;

FIG. 7 is a flow chart that illustrates the operation of UE in accordance with another embodiment of the present disclosure;

FIG. 8 is a flow chart that illustrates the operation of a first network node in accordance with one embodiment of the present disclosure

FIG. 9 is a schematic block diagram of a network node according to some embodiments of the present disclosure;

FIG. 10 is a schematic block diagram that illustrates a virtualized embodiment of the network node of FIG. 9 according to some embodiments of the present disclosure;

FIG. 11 is a schematic block diagram of the network node of FIG. 9 according to some other embodiments of the present disclosure;

FIG. 12 is a schematic block diagram of a User Equipment device (UE) according to some embodiments of the present disclosure;

FIG. 13 is a schematic block diagram of the UE of FIG. 12 according to some other embodiments of the present disclosure;

FIG. 14 illustrates a telecommunication network connected via an intermediate network to a host computer in accordance with some embodiments of the present disclosure;

FIG. 15 is a generalized block diagram of a host computer communicating via a base station with a UE over a partially wireless connection in accordance with some embodiments of the present disclosure;

FIG. 16 is a flowchart illustrating a method implemented in a communication system in accordance with one embodiment of the present disclosure;

FIG. 17 is a flowchart illustrating a method implemented in a communication system in accordance with one embodiment of the present disclosure;

FIG. 18 is a flowchart illustrating a method implemented in a communication system in accordance with one embodiment of the present disclosure; and

FIG. 19 is a flowchart illustrating a method implemented in a communication system in accordance with one embodiment of the present disclosure.

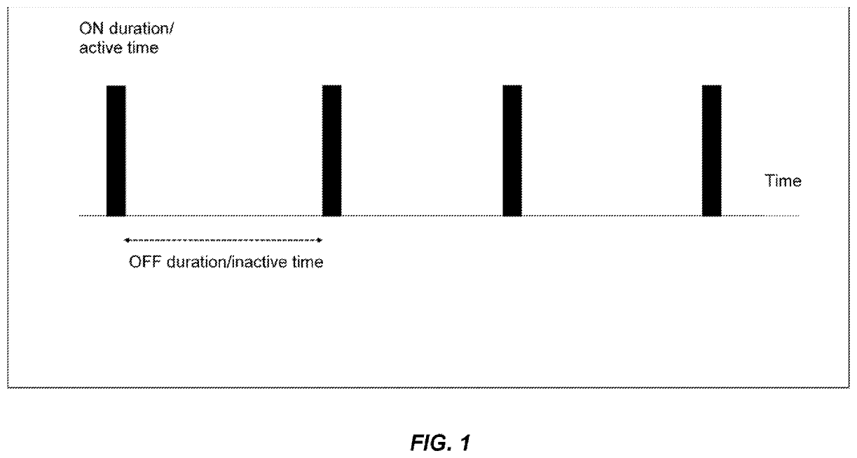

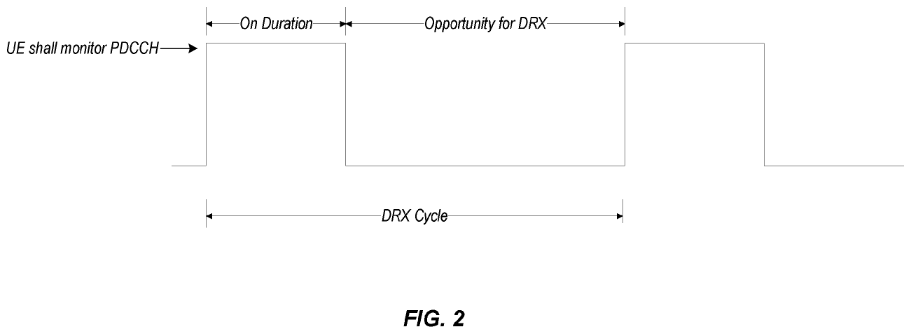

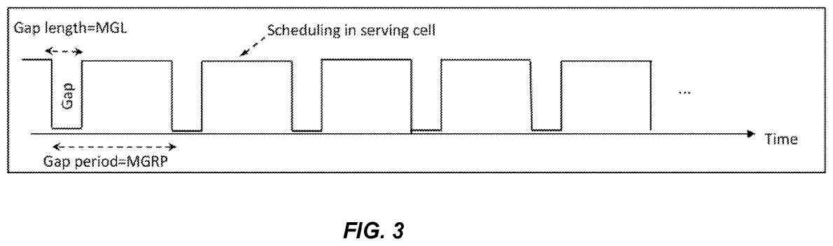

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

In the present disclosure, the term “node” is used to generally refer to either a network node or a User Equipment (UE).

Examples of network nodes are NodeB, Base Station (BS), Multi-Standard Radio (MSR) radio node such as MSR BS, eNodeB (eNB), gNodeB (gNB), Master eNB (MeNB), Secondary eNB (SeNB), Location Measurement Unit (LMU), Integrated Access Backhaul (IAB) node, network controller, Radio Network Controller (RNC), Base Station Controller (BSC), relay, donor node controlling relay, Base Transceiver Station (BTS), Central Unit (e.g. in a gNB), Distributed Unit (e.g. in a gNB), Baseband Unit, Centralized Baseband, Cloud RAN (C-RAN), Access Point (AP), transmission points, transmission nodes, Transmission Reception Point (TRP), Remote Radio Unit (RRU), Remote Radio Head (RRH), nodes in Distributed Antenna System (DAS), core network node (e.g. Mobile Switching Center (MSC), Mobility Management Entity (MME), Access and Mobility Management Function (AMF), etc.), Operations and Management (O&M), Operations and Support System (OSS), Self-Organizing Network (SON), positioning node (e.g. Evolved Serving Mobile Location Center (E-SMLC)), etc.

The non-limiting term “UE” refers to any type of wireless device communicating with a network node and/or with another UE in a cellular or mobile communication system. Examples of a UE are target device, Device to Device (D2D) UE, Vehicular to Vehicular (V2V), machine type UE, Machine Type Communication (MTC) UE or UE capable of Machine to Machine (M2M) communication, Personal Digital Assistant (PDA), tablet, mobile terminals, smart phone, Laptop Embedded Equipment (LEE), Laptop Mounted Equipment (LME), Universal Serial Bus (USB) dongle, etc.

The term “radio access technology”, or “RAT”, may refer to any RAT, e.g. Universal Terrestrial Radio Access (UTRA), Evolved UTRA (E-UTRA), narrow band internet of things (NB-IoT), Wifi, Bluetooth, next generation RAT, New Radio (NR), 4G, 5G, etc. Any of the equipment denoted by the term node, network node or radio network node may be capable of supporting a single or multiple RATs.

The term “signal” or “radio signal” used herein can be any physical signal or physical channel. Examples of DL physical signals are reference signal (RS) such as Primary Synchronization Signal (PSS), Secondary Synchronization Signal (SSS), Channel State Information (CSI) Reference Signal (CSI-RS), Demodulation Reference Signal (DMRS) signals in SS/PBCH block (SSB), Discovery Reference Signal (DRS), Cell-specific Reference Signal (CRS), Positioning Reference Signal (PRS), etc. RS may be periodic, e.g. RS occasion carrying one or more RSs may occur with certain periodicity, e.g. 20 ms, 40 ms, etc. The RS may also be aperiodic. Each SSB carries NR PSS (NR-PSS), NR SSS (NR-SSS), and NR Physical Broadcast Channel (NR-PBCH) in four successive symbols. One or multiple SSBs are transmit in one SSB burst which is repeated with certain periodicity, e.g. 5 ms, 10 ms, 20 ms, 40 ms, 80 ms, and 160 ms. The UE is configured with information about SSB on cells of certain carrier frequency by one or more SS/PBCH block Measurement Timing Configuration (SMTC) configurations. The SMTC configuration comprises parameters such as SMTC periodicity, SMTC occasion length in time or duration, SMTC time offset with respect to a reference time (e.g., serving cell's System Frame Number (SFN)), etc. Therefore, SMTC occasion may also occur with certain periodicity, e.g. 5 ms, 10 ms, 20 ms, 40 ms, 80 ms, and 160 ms. Examples of UL physical signals are reference signal such as Sounding Reference Signal (SRS), DMRS, etc. The term “physical channel” refers to any channel carrying higher layer information, e.g data, control, etc. Examples of physical channels are PBCH, Narrowband PBCH (NPBCH), Physical Downlink Control Channel (PDCCH), Physical Downlink Shared Channel (PDSCH), Physical Uplink Control Channel (PUCCH), Physical Uplink Shared Channel (PDSCH), short PUCCH (sPUCCH), short PDSCH (SPDSCH), short PUCCH (sPUCCH), short PUSCH (sPUSCH), MTC PDCCH (MPDCCH), Narrowband PDCCH (NPDCCH), Narrowband PDSCH (NPDSCH), Enhanced PDCCH (E-PDCCH), Narrowband PUSCH (NPUSCH), etc.

The term “time resource” used herein may correspond to any type of physical resource or radio resource expressed in terms of length of time. Examples of time resources are: symbol, sub-slot, mini-slot, slot or time slot, subframe, radio frame, Transmission Time Interval (TTI), interleaving time, SFN cycle, hyper-SFN cycle, etc.

The term “multi-USIM” or “MUSIM” used herein may also be called as multi-subscription, multi-SIM, dual SIM, dual-USIM, etc. The term “Universal Subscriber Identity Module” or “USIM” may also be simply called Subscriber Identity Module (SIM). For consistency, multi-USIM term may be used hereinafter. Each USIM (or SIM) in the UE may be associated with at least subscription of a mobile network operator (MNO).

The term “request” is used herein, but the intention is mainly to point out that the UE can have a preference to indicate to the network. In other words, the “UE request” can be understood as a “UE preference”, or “UE indication of a preference”, and may not require any network response.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

There exist certain challenges. In the multi-USIM scenario, the UE capable of multi-USIM is served by at least two serving cells which belong to different networks. The UE performs measurements and/or receives one or more signals (e.g., system information, data, control signal, paging, etc.) and/or transmits one or more signals (e.g., data, control signal, reference signal such as Sounding Reference Signal (SRS), random access, etc.) in at least two cells during at least partially overlapping time period, e.g. when served by at least the two networks.

One problem is that unlike legacy multi-carrier operation (e.g., carrier aggregation, multi-connectivity, etc.), in multi-USIM scenario, one serving cell operated or managed by one network may not be aware of the UE operation (e.g., measurements, etc.) in the other serving cell(s) operated or managed by the other networks. This may cause severe impact in terms of interruption or loss of signals in a serving cell due to operations in other serving cells. The interruptions can also be unpredictable i.e., the UE may not have advance information of the interruptions. This causes loss of data in the serving cell where interruption occurs.

One of the important UE operations when in the Idle/Inactive mode with respect to a network (NW2) is SI acquisition. As mentioned in the background section above, the SI acquisition window is associated with the SSB transmission. The UE can calculate the candidate SI position(s) based on its detected strongest SSB(s).

To avoid unpredictable long interruption due to SI acquisition (the SI window can be at most 1280 slots), the UE can be configured with measurement gaps. Frequent gaps or long measurement gap length may also degrade the system throughput. Therefore, new procedures are needed to configure the gaps in an efficient manner. Furthermore, the network (NW1) with which the UE is in CONNECTED mode shall have information on possible candidate SI position(s) for UE in NW2.

Systems and methods that address the aforementioned and/or other challenges are described herein. The scenario comprises a UE which is configured to operate in multi-USIM scenario where: the UE's first serving cell (cell1) and a first network node (NN1) managing or serving cell 1 are comprised in a first network (NW1); and the UE's second serving cell (cell2) and a second network node (NN2) managing or serving cell2 are comprised in a second network (NW2). The UE may further be configured to perform measurement on a third cell (cell3) comprised in NW2.

Embodiments covering methods in a UE, in a first network node (NN1), and in a second network node (NN2) are disclosed herein. Some example embodiments are as follows:
In a first embodiment, the UE calculates a set of candidate SI acquisition positions in cell2which meet a reference signal (RS) (e.g., SSB) detection condition and sends a preference to NN1 to be configured with a set of aperiodic measurement gaps based on the candidate SI positions. The UE may further be configured by NNI with one or more measurement gaps based on the preference and may further use the measurement gaps for one or more operational tasks, e.g. for acquiring the SI of cell1 or cell3.
In a second embodiment, the UE detects a set of candidate RS indices (e.g., SSB indices) which meets the RS (e.g., SSB) detection condition and reports the information about related one or more parameters to NN1. Examples of the parameters are candidate RS indices (e.g., SSB indices), SI window w, SI periodicity T, and the mapping between control channel (e.g., PDCCH) monitoring occasions for SI acquisition and SSBs in searchSpaceOtherSystemInformation, and validity of the report. The UE may further be configured by NN1 with one or more measurement gaps based on the UF preference and may further use the measurement gaps for one or more operational tasks, e.g. for acquiring the SI of cell1 or cell3.
In a third embodiment, the NN1 configures the UE with J1 number of measurement gaps.
   Examples of J1 measurement gaps can be based on UE preference for N1 number of measurement gaps and one or more measurement gap related parameters (e.g., MGL, MGO, etc.).
   Examples of J1 measurement gaps can be based on calculation of required number of measurement gaps by NN1 itself.
   Examples of J1 measurement gaps can be candidate MGPs which meet the signal reception proximity (SRP) condition. The SRP defines a time gap (Tg) between any two gaps used for or preferred by the UE for the SI acquisition in cell2.

In one embodiment, in a multi-USIM operational scenario, the UE reports to cell1 in NW1 the possible candidate positions for SI acquisition in cell2 in NW2. The measurement gap(s) for SI acquisition can be either explicitly indicated as a preference by the UE in terms of possible gap windows (gap start slot #a and gap length L) or implicitly indicated as a preference by the UE in terms of candidate strongest SSB index(es) or with possible parameters related to SI acquisition window, such as x, N, and SI periodicity T, where N is the number of actual transmitted SSBs determined according by the UF to ssb-PositionsInBurst in SIB1 and X is equal to CEIL (number of PDCCH monitoring occasions in SI-window/N).

While not being limited to or by any particular advantages, embodiments disclosed herein may provide a number of advantages over existing solutions. Some example advantages that may be provided by at least some of the embodiments described herein are as follows:
The UE measurement behavior in multi-USIM operational scenario is well defined.
The mechanism ensures that the network performance degradation is limited due to SI acquisition for multi-USIM operation.
The mechanism ensures that UE does not lose critical signals (e.g., system information etc.) in multi-USIM operational scenario.
The measurement gap configuration rules in multi-USIM operational scenario enable each network to prevent too much loss of grants/resources used by the UE for signal reception/transmission.

As mentioned above, embodiments of the present disclosure relate to the following scenario. The scenario comprises a UE served by at least two cells: a first cell (cell1) and a second cell (cell2). Cell1 and cell2 may operate on or belong to or configured using: a first carrier frequency (F1) and a second carrier frequency (F2) respectively. The carrier frequency is also called as component carrier (CC), frequency layer, serving carrier, frequency channel, etc. The carrier frequency related information is signaled to the UE using a channel number, e.g. Absolute Radio Frequency Channel Number (ARFCN), NR ARFCN (NR-ARFCN), etc. F1 and F2 may belong to the same or different frequency bands. The coverage areas of cell1 and cell2 may fully overlap or may not overlap at all or may partially with respect to each other.

Cell1 in turn is served or managed or controlled by a first network node (NN1) which is comprised in a first network (NW1). Cell2 in turned is served or managed or controlled by a second network node (NN2) which is comprised in a second network (NW2). Therefore, the UE is served by or managed by the at least two networks (NW1 and NW2). In one example, NW1 and NW2 may be managed by or belong to the same operator. In another example, NW1 and NW2 may be managed by or belong to different operators. This is realized by the UE capable of multi-USIM operation, i.e. supporting at least 2 USIMs. For example, one of the supported USIM is associated with subscription to NW1, while the other supported USIM is associated with subscription to NW2. In one scenario the UE is served by one serving cell in each NW, e.g. by cell1 and cell2 in NW1 and NW2 respectively. In another exemplary scenario the UE may further be served by more than one cell in NW1 and/or by more than one cell in NW2.

Examples of cells are serving cell, neighbor cell, non-serving cell, etc. In multicarrier (MC) operation, the UE is served by more than one serving cells. Each cell may operate or belong to a carrier frequency.

Examples of MC operations are carrier aggregation (CA), dual connectivity (DC), multi-connectivity (MuC), etc. The carrier frequency is also called as component carrier (CC), frequency layer, serving carrier, frequency channel, etc. Examples of serving cells are special serving cell or special cell (SpCell), secondary serving cell or secondary cell (SCell), etc. SpCell may be more important than SCell as it may carry some control signaling. Examples of SpCell are primary serving cell or primary cell (PCell), primary secondary serving cell or primary secondary cell (PSCell), etc. The carrier frequencies of SpCell, SCell, PCell and PSCell are called as special CC (SpCC) or simply SpC, secondary CC (SCC), primary CC (PCC) and primary secondary CC (PSCC) or simply PSC respectively. In CA the UE has one PCell and one or more SCells. DC comprises a master cell group (MCG) which contains at least a PCell and a secondary cell group (SCG). Each of MCG and SCG may further contain one or more SCells. The PCell manages (e.g., configures, changes, release etc.) all SCells in MCG and PSCell in SCG. PSCell manages all SCells in SCG. The cells in MCG and SCG may belong to the same RAT (e.g., all cells are NR in both MCG and SCG like in NR-DC) or they may belong to different RATs (e.g., LTE cells in MCG and NR cells in SCG like in EN-DC or NR cells in MCG and LTE cells in SCG like in NE-DC).

Even though the embodiments are described assuming that the UE is served by one cell in NN1 and one cell in NN2; but they are applicable for any number of cells serving the UE in any network. In one example cell1 and cell2 are sPCell1 and sPCell2 respectively.

NN1 and NN2 may be two different logical network nodes as well as two different physical network nodes. In another example, NN1 and NN2 may be two different logical network nodes but may be comprised in the same physical network node. NN1 and NN2 may or may not be physically located at the same site.

The UE may be served by cell1 and cell2 during at least partially overlapping time period. In one example, the UE is served by cell1 during time period D1 and by cell2 during time period D2. In one example, D1 and D2 may fully overlap in time, e.g. D1 and D2 start at the same time instance and also end at the same time instance. In another example, D1 and D2 may only partially overlap in time, e.g. D1 and D2 may start at the same time but end at different time instances, or D1 and D2 may start at different time instances but end at the same time instance, or D1 and D2 may start at different time instances and also end at different time instances.

In one example, the UE may be configured to operate in the same RRC activity state with regard to cell1 and cell2 during at least partially overlapping time. In another example, the UE may be configured to operate in different RRC activity states with regard to cell1 and cell2 during at least partially overlapping time. Examples of RRC activity states are low activity RRC state, high activity state, etc. In low activity RRC state, the UE may typically be configured to operate using a DRX cycle which is equal to or larger than certain threshold, e.g. 320 ms or longer. In high activity RRC state the UE may or may not be configured to operate with a DRX cycle, or may be configured with any DRX cycle when configured. Examples of low activity RRC state are RRC idle state, RRC inactive state, etc. Examples of high activity RRC state are RRC connected state, etc.

In some embodiments, a scenario is considered where the UE is served by cell1 in NN1 in high activity RRC state (e.g., RRC connected state) but is served by cell2 in NN2 in any of the low activity state and high activity RRC state In some embodiments, a scenario is considered where the UE is served by cell1 in NN1 in high activity RRC state but is served by cell2 in NN2 in the low activity state (e.g., RRC idle state or RRC inactive state).

In some embodiments, a scenario is considered where the UE served by cell2 in NW2is further configured to perform a cell change to a third cell (cell3). Examples of cell change procedures are cell reselection from cell2 to cell3, cell selection to cell3 (e.g., after losing connection to cell2), RRC connection release with redirection to cell3, RRC connection re-establishment to cell3, etc. In one scenario, cell3 may operate on the same carrier frequency as that of cell2, i.e. F2. In another scenario, cell3 may operate on a third carrier frequency (F3) which is different than F2.

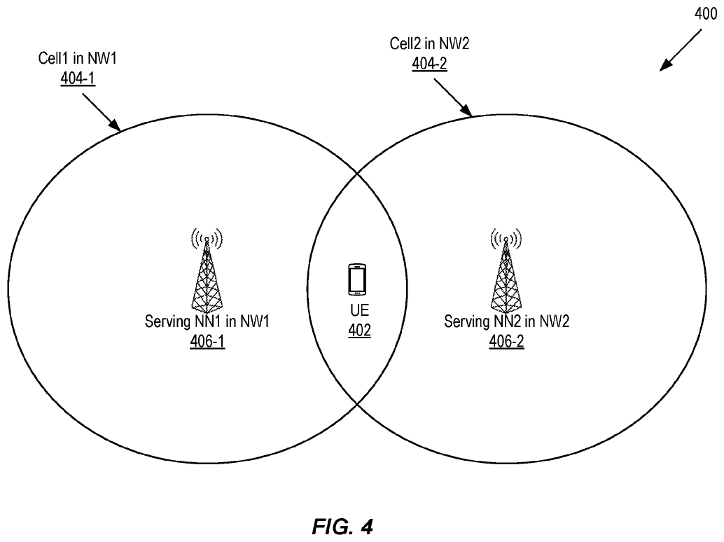

FIG. 4 illustrates an example of a cellular communications system 400 in which multi-USIM operation of a UE 402 is provided in accordance with an embodiment of the present disclosure. The UE 402 is a MUSIM UE. The UE 402 is served at a first cell 404-1 (i.e., cell1) that is managed or served or controlled by a first network node 406-1 (i.e., NN1) in a first network (i.e., NW1) and served at a second cell 404-2 (i.e., cell2) that is managed or served or controlled by a second network node 406-2 (i.e., NN2) in a second network (i.e., NW2). The scenarios described above and illustrated in FIG. 4 are applicable to all the embodiments described herein.

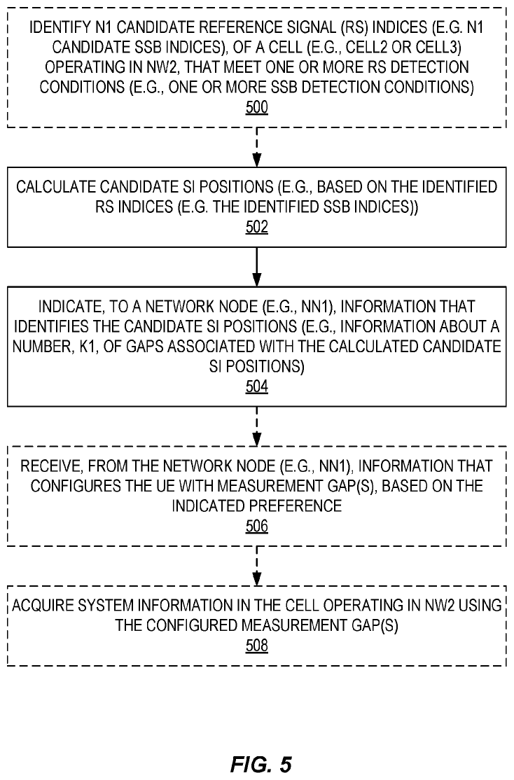

Embodiments of a method in a UE for indicating a preferred measurement gap pattern(s) associated with strongest RSs (e.g., strongest SSBs) are disclosed. In this regard, FIG. 5 illustrates a first embodiment of a method in the UE 402 served by the first cell 404-1 (i.e., cell1) that is served by or managed by the first network node 406-1 (i.e., NN1), and by the second cell 404-2 (i.e., cell2) that is served by or managed by the second network node 406-2 (i.e., NN2). Optional steps are represented by dashed lines/boxes. As illustrated, the method of FIG. 5 includes the following:
Step 500 (optional): The UE 402 identifies N1 candidate reference signal (RS) indices (e.g., N1 candidate SSB indices), of a cell (e.g., cell2 or cell3) operating in NW2, that meet one or more RS detection conditions (e.g., one or more SSB detection conditions).
Step 502: The UE 402 calculates candidate SI positions, e.g., based on the identified RS indices (e.g., the identified SSB indices) from step 500.
Step 504: The UE 402 indicates, to a network node (e.g., NN1), information that identifies the candidate SI positions. In one embodiment, the information that identifies the candidate SI positions comprises information about K1 number of gaps associated with the calculated candidate SI positions. In one example, the information about the K1 number of gaps comprises information that indicates K1, i.e., the number of gaps. In another example, the information comprises gap configuration of one or more of the K1 number of gaps. The gap configuration may comprise one or more of: MGL, MG time offset with respect to a reference time, time location of the gap with respect to a reference time (e.g., time resource number, SFN number, slot number, subframe number, etc.), etc.
Step 506 (optional): The UE 402 receives, from the network node, information that configures the UE 402 with one or more measurement gaps, in accordance with the indicted preference.
Step 508 (optional): The UE 402 acquires SI for the cell (e.g., cell2 or cell3) operating in NW2 using the configured measurement gap(s).

The above steps and various actions performed in the UE 402 and criteria, etc. are described below with several examples.

The UE 402 may be configured to acquire the SI of a cell which belongs to or operates in NW2. Examples of the cell in NW2 are cell2, cell3, etc. Therefore, the above steps may be related to or applicable for the SI acquisition in any cell operating in NW2, and during any type of procedure which requires SI of the cell (e.g., cell reselection, cell selection, etc.).

A downlink (DL) RS (e.g., SSB, CS-RS) may also be referred to as a DL signal, DL beam, spatial filter, spatial domain transmission filter, main lobe of the radiation pattern of antenna array, etc. The RS or beams may be addressed or configured by an identifier, which can indicate the location of the RS or beam in time in RS pattern or beam pattern, e.g. RS or beam index such as SSB index indicate SSB beam location in the pre-defined SSB format/pattern. For example, the RS index used herein may refer to index of any type of RS such as SSB index, CSI-RS index etc.

The UE 402 may acquire the RS indices of RS transmitted by a cell in NW2 during one or more measurement procedures involved the RS, e.g. during the cell identification procedure.

Examples of one or more criteria for meeting one or more RS detection (e.g., SSB detection) conditions are as follows.

In one example, the UE 402 identifies N1 candidate RS indices (e.g., SSB indices) by detecting or estimating or determining the received power of the RSs (e.g., SSBs) that are larger than a threshold Tssb. The received power can be determined or expressed in terms of signal strength or signal quality of the received RS, e.g. SSB signals. Examples of signal strength are path loss, Reference Signal Receive Power (RSRP), etc. Examples of signal quality are Reference Signal Receive Quality (RSRQ), Signal to Interference plus Noise Ratio (SINR), Signal to Noise Ratio (SNR), etc. The threshold Tssb can be:
Pre-defined in a 3GPP specification or the like;
Configured by a network node, e.g. NN1, NN2, etc.;
Up to the UE implementation.

In another example, instead of detecting the received power larger than a threshold, in step 500, the UE 402 can identify M1 candidate RS indices (e.g., SSB indices) based on M1 strongest received power of RS indices (e.g., SSB indices) by descending order of the received power for each RS index (e.g., SSB index). The received power calculation can be determined or expressed in terms of signal strength (e.g., RSRP) or signal quality (e.g., RSRQ) of the received SSB signals. The parameter M1 can be:
Pre-defined in a 3GPP specification or the like;
Configured by a network node, e.g. NN1, NN2, etc.;
Up to the UE implementation.

Examples of calculating the candidate SI positions can be as follows.

The UE 402 calculates the SI window start position slot #a based on SI-window length w, SI periodicity T. After that, the UE 402 maps the candidate PDCCH monitoring occasions for SI acquisition based on detected SSB indexes by searchSpaceOtherSystemInformation, if searchSpaceOtherSystemInformation is not set to zero.

Otherwise, the mapping relation parameters between PDCCH monitoring occasions for SI acquisition and SSBs will followed the SIBI mapping parameters.

Examples of the information about the number, K1, of measurement gaps (e.g., provided a preference of the UE for the number, K1, of measurement gaps) can be as follows.

The UE 402 indicates a preference to NN1 (e.g., via cell1) to configure K1 number of gaps to for the SI acquisition of a cell operating in or belong to NW2 (e.g., cell2, cell3), where K1 depends on a relation between distance in time among any two SI acquisition positions and a threshold D1. In one example K1=N1 and in another example K1<N1 e.g.
In one example, the UE 402 indicates a preference of K1 number of gaps at one time which can be the aperiodic gaps, where K1=N1. After the calculating the candidate SI acquisition positions, if all the distance in time among any two SI acquisition positions is larger than a threshold D1, then the UE 402 will indicate the preferred number of gaps equals N1.
In another example, the UE 402 indicates a preference of K1 gaps at one time which can be the aperiodic gaps, where K1<N1. After the calculating the candidate SI acquisition positions, if the distance in time between any two of the SI acquisition positions is equal to or smaller than a threshold D1, then the UE 402 will only prefer one gap to detect both SIs. Therefore, the total preference number of gaps will be K1<N1.

The parameter D1 can be:
Pre-defined in a 3GPP specification or the like;
Configured by a network node, e.g. NN1, NN2, etc.;
Up to the UE implementation.

In one example, the information about the number, K1, of measurement gaps may include, in one embodiment, one or more parameters for at least one of but potentially all of the K1 gaps preferred by the UE 402. These one or more parameters may include one or more of the following
Measurement gap length (MGL)
   The UE 402 can indicate the preferred aperiodic gap(s) with the same MGL or several gaps with different MGLs.
   In one example, the measurement gap length can be equal to 2*RF retuning time+(PDCCH monitoring slots+PDSCH slot)*NN2 NR slot length+1 ms, if NN1 and NN2 are asynchronous with respect to each other, and 2*RF retuning time+(PDCCH monitoring slots+PDSCH slot)*NN2 NR slot length, if NN1 and NN2 are synchronous with respect to each other. The RF retuning time can be 2 ms. The RF tuning is used by the UE 402 for switching or changing one or more parameters related to a carrier frequency, e.g. center frequency, bandwidth.
   In another example, the measurement gap length can be equal to 2*RF retuning time+2 slots*NN2 NR slot length+1 ms if NN1 and NN2 are asynchronous with respect to each other, and 2*RF retuning time+2 slots*NN2 NR slot length if NN1 and NN2 are synchronous with respect to each other. NN1 and NN2 are synchronous with respect to each other if the magnitude of the time difference (ΔT) between signals received at the UE from cell1 and cell2 is equal to or less than certain threshold (Ht). Otherwise (if |ΔT|>Ht), NN1 and NN2 are asynchronous with respect to each other. An example of ΔT=±33 μs for subcarrier spacing (SCS)=15 kHz.
   In another example, the measurement gap length can be 10 ms.
Measurement gap offset (MGO)
   Measurement gap offset can be also called as measurement gap start position (MGSP).
   The UE 402 can indicate a preference of sequence of MGOs/MGSPs related to each candidate gap
      The measurement gap #i start position can be the slot #a for start SI window in NN2+Koffset,i. In one example, Koffset,i is defined by the mapping between control channel (e.g., PDCCH) monitoring occasion #i and the strongest SSB #i in searchSpaceOtherSystemInformation.

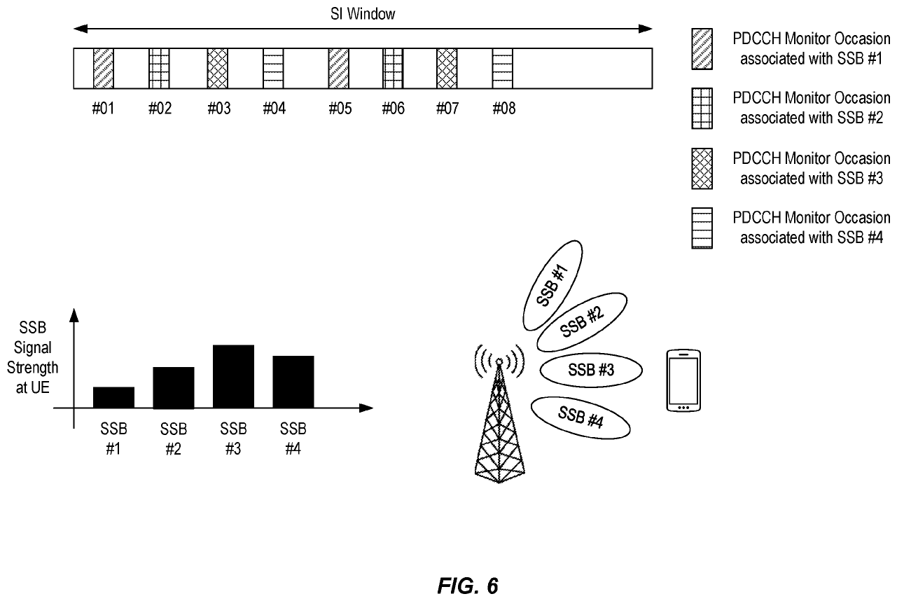

In an example embodiment shown in FIG. 6, the UE 402 will identify two strongest SSB indexes, SSB #3, SSB #4. After that, the UE 402 calculates the candidate control channel (e.g., PDCCH) monitoring occasions. The possible control channel (e.g., PDCCH) monitoring occasions can be #O3, #O4, O #7, O #8. The UE 402 prefers four aperiodic gaps associated with these control channel (e.g., PDCCH) monitoring occasions, in this example. If the UE 402 cannot successfully detect the SI for one time, then the UE 402 will further indicate the preference of another four aperiodic gaps based on SI periodicity.

The UE 402 may further be configured with one or more measurement gaps by NN1, and the UE 402 may further use the configured measurement gaps for one or more operational tasks, e.g. for acquiring the SI of a cell in NW2 (e.g., cell2, cell3), releasing the configured measurement gaps after the SI acquisition, informing NN1 that the configured measurement gaps are not needed anymore or that they are released etc.

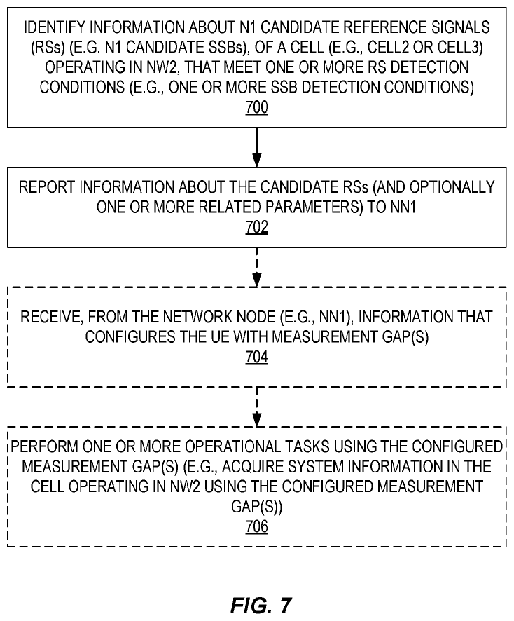

Embodiments of a method in a UE for indicating a preferred measurement gap pattern(s) associated with SI parameters. In this regard, FIG. 7 illustrates a second embodiment of a method in the UE 402 served by the first cell 404-1 (i.e., cell1) that is served by or managed by the first network node 406-1 (i.e., NN1), and by the second cell 404-2 (i.e., cell2) that is served by or managed by the second network node 406-2 (i.e., NN2). Optional steps are represented by dashed lines/boxes. As illustrated, the method of FIG. 7 includes the following:
Step 700: The UE 402 identifies information about N1 candidate RSs (e.g., SSBs), of a cell (e.g., cell2 or cell3) in NW2, that meet the RS (e.g., SSB) detection conditions. The information about the N1 candidate RSs may include, e.g., RS indices of the N1 candidate RSs.
Step 702: The UE 402 reports information about the candidate RSs and, optionally, one or more related parameters to NN1. The information about the candidate RSs may include, e.g., the identified RS indices (e.g., SSB indices). The one or more related parameters may include, in one embodiment, SI-window length w, SI periodicity T, the mapping between control channel (e.g., PDCCH) monitoring occasions for SI acquisition and RSs (e.g., SSBs) in searchSpaceOtherSystemInformation, or any combination thereof.
Step 704 (optional): The UE 402 receives, from the network node (e.g., NN1), information that configures the UE 402 with one or more measurement gaps, in accordance with the indicted preference.
Step 706 (optional): The UE 402 performs one or more operational tasks using the configured measurement gap(s) (e.g., acquires SI for the cell (e.g., cell2 or cell3) operating in NW2 using the configured measurement gap(s)).

The above steps and various actions performed in the UE 402 and criteria are described below with several examples.

The UE 402 may be configured to acquire the SI of a cell which belongs to or operate in NW2. Examples of the cell in NW2 are cell2, cell3, etc. Therefore, the above steps may be related to or applicable for the SI acquisition in any cell operating in NW2, and during any type of procedure which requires SI of the cell (e.g., cell reselection, cell selection etc.).

Examples of one or more criteria for meeting one or more RS (e.g., SSB) detection conditions are the same as described with examples in the first embodiment (i.e., the embodiments described above relating to the method in a UE for indicating a preferred measurement gap pattern(s) associated with strongest RSs (e.g., strongest SSBs)).

Examples of one or more criteria for reporting the related parameters to NN1 can be as follows.

In one example, the UE 402 reports to cell1, the identified SSB indexes, SI-window length w, SI periodicity T, SCS in NN2 and the mapping relation parameters between control channel (e.g., PDCCH) monitoring occasions for SI acquisition and SSBs in searchSpaceOtherSystemInformation, such as control channel (e.g., PDCCH) periodicity, and offset, if searchSpaceOtherSystemInformation is not set to zero. Otherwise, the mapping relation parameters between PDCCH monitoring occasions for SI acquisition and SSBs will followed the SIB1 mapping parameters.

The UE 402 may further be configured with one or more measurement gaps by NN1, and the UE 402 may further use the configured measurement gaps for one or more operational tasks, e.g. for acquiring the SI of a cell in NW2 (e.g., cell2, cell3), releasing the configured measurement gaps after the SI acquisition, informing NNI that the configured measurement gaps are not needed anymore or that they are released etc. (steps 704 and 706, each of which is optional).

Embodiments of a method in a first network node for configuring measurement gap pattern(s) based on UE preferred parameters are also disclosed. In this regard, as illustrated in FIG. 8, in a third embodiment, according to a method in the first network node 406-1 (i.e., NN1) serving the UE 402 in the first cell 404-1 (i.e., cell1):
Step 800: NN1 determines a number, J1, of measurement gaps, which meets at least one signal reception proximity (SRP) condition. SRP defines a time gap (Tg) between any two gaps used for or preferred by the UE for the SI acquisition in cell2. The SRP condition is met if Tg is equal to or smaller than certain threshold; otherwise, the SRP is not met; and
Step 802: NN1 configures the UE 402 with the determined number, J1, of measurement gaps.

The above steps and various actions performed in NN1 and criteria etc. are described below with several examples:
1. In one example, NN1 configures J1=N1 measurement gaps directly based on UE's preference of N1 MGs. The parameters from the UE preference can be also reused.
2. In another example, NN1 will only configure J1=1 measurement gap based on the earliest MGO (e.g., MGSP) preferred by the UE. If the UE doesn't successfully report the acquired SI or the UE indicates of the preferred measurement gap with the same parameters again, then NN1 will configure J1=2 measurement gaps based on the earliest two MGO (e.g., MGSP) preferred by the UE. And so on, until UE successfully detect the SIs or the UE requests to release the MGPs.
3. In another example, NN1 configures J1 measurement gaps based on SRP conditions. The signal reception proximity (SRP) conditions are described below.

In one example, if the distance in time between any two of UE preferred gap positions is equal to or smaller than a threshold D1, then NN1 will only configure one gap to detect both SIs. If the distance in time between any two of the UE preferred gap positions is larger than a threshold D1, then NN1 will configure the gap number J1 equals the number preferred by UE, such as N1.

In another example, the NN1 will calculate the possible candidate SI acquisition positions based on the parameters reporting by UE. If the distance in time between any two of calculated SI acquisition positions is equal to or smaller than a threshold D1, then NN1 will only configure one gap to detect both SIs. If all the distance in time between any two of the calculated SI acquisition positions is larger than a threshold D1, then NN1 will configure more than one gaps (independent gaps) based on the calculated positions of the gaps.

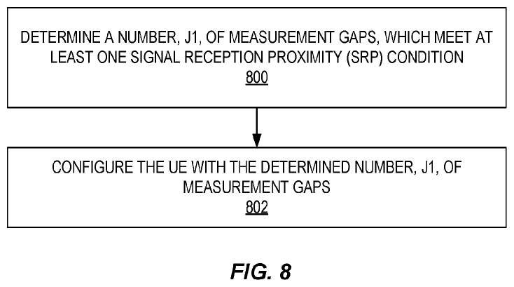

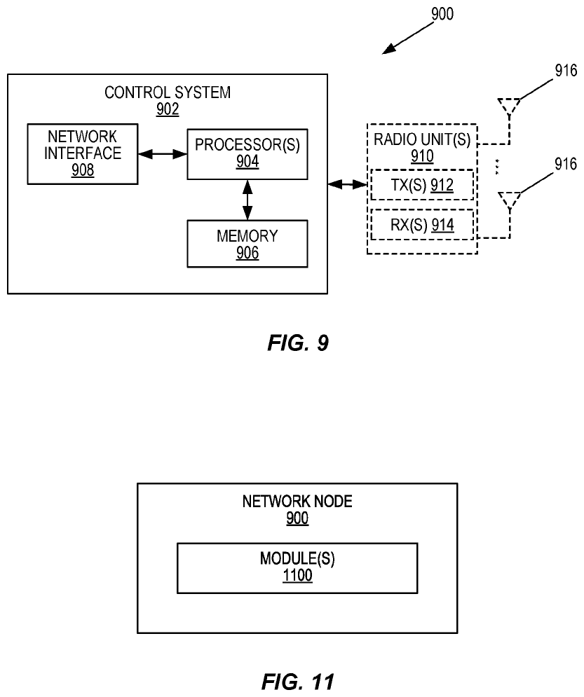

FIG. 9 is a schematic block diagram of a network node 900 according to some embodiments of the present disclosure. Optional features are represented by dashed boxes. The network node 900 may be, for example, the first network node 406-1 or the second network node 406-2. As illustrated, the network node 900 includes a control system 902 that includes one or more processors 904 (e.g., Central Processing Units (CPUs), Application Specific Integrated Circuits (ASICs), Field Programmable Gate Arrays (FPGAs), and/or the like), memory 906, and a network interface 908. The one or more processors 904 are also referred to herein as processing circuitry. In addition, the network node 900 may include one or more radio units 910 that each includes one or more transmitters 912 and one or more receivers 914 coupled to one or more antennas 916. The radio units 910 may be referred to or be part of radio interface circuitry. In some embodiments, the radio unit(s) 910 is external to the control system 902 and connected to the control system 902 via, e.g., a wired connection (e.g., an optical cable). However, in some other embodiments, the radio unit(s) 910 and potentially the antenna(s) 916 are integrated together with the control system 902. The one or more processors 904 operate to provide one or more functions of a network node 900 as described herein (e.g., one or more functions of the first network node 406-1 or the second network node 406-2, as described herein). In some embodiments, the function(s) are implemented in software that is stored, e.g., in the memory 906 and executed by the one or more processors 904.

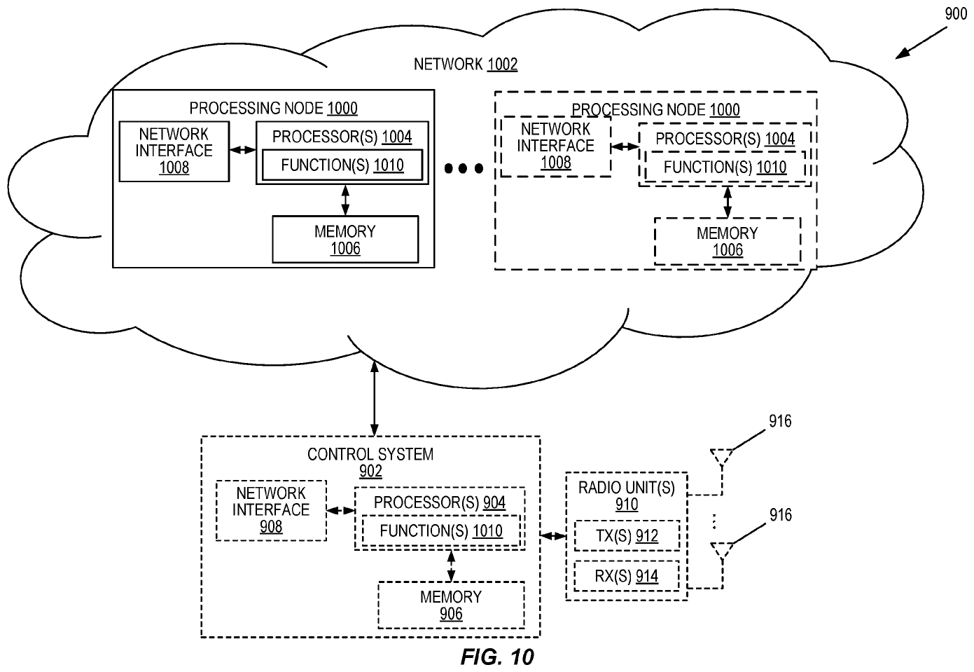

FIG. 10 is a schematic block diagram that illustrates a virtualized embodiment of the network node 900 according to some embodiments of the present disclosure. Again, optional features are represented by dashed boxes. As used herein, a “virtualized” network node is an implementation of the network node 900 in which at least a portion of the functionality of the network node 900 is implemented as a virtual component(s) (e.g., via a virtual machine(s) executing on a physical processing node(s) in a network(s)). As illustrated, in this example, the network node 900 may include the control system 902 and/or the one or more radio units 910, as described above. The control system 902 may be connected to the radio unit(s) 910 via, for example, an optical cable or the like. The network node 900 includes one or more processing nodes 1000 coupled to or included as part of a network(s) 1002. If present, the control system 902 or the radio unit(s) are connected to the processing node(s) 1000 via the network 1002. Each processing node 1000 includes one or more processors 1004 (e.g., CPUs, ASICs, FPGAs, and/or the like), memory 1006, and a network interface 1008.

In this example, functions 1010 of the network node 900 described herein (e.g., one or more functions of the first network node 406-1 or the second network node 406-2, as described herein) are implemented at the one or more processing nodes 1000 or distributed across the one or more processing nodes 1000 and the control system 902 and/or the radio unit(s) 910 in any desired manner. In some particular embodiments, some or all of the functions 1010 of the network node 900 described herein are implemented as virtual components executed by one or more virtual machines implemented in a virtual environment(s) hosted by the processing node(s) 1000. As will be appreciated by one of ordinary skill in the art, additional signaling or communication between the processing node(s) 1000 and the control system 902 is used in order to carry out at least some of the desired functions 1010. Notably, in some embodiments, the control system 902 may not be included, in which case the radio unit(s) 910 communicate directly with the processing node(s) 1000 via an appropriate network interface(s).

In some embodiments, a computer program including instructions which, when executed by at least one processor, causes the at least one processor to carry out the functionality of network node 900 or a node (e.g., a processing node 1000) implementing one or more of the functions 1010 of the network node 900 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 11 is a schematic block diagram of the network node 900 according to some other embodiments of the present disclosure. The network node 900 includes one or more modules 1100, each of which is implemented in software. The module(s) 1100 provide the functionality of the network node 900 described herein (e.g., one or more functions of the first network node 406-1 or the second network node 406-2, as described herein). This discussion is equally applicable to the processing node 1000 of FIG. 10 where the modules 1100 may be implemented at one of the processing nodes 1000 or distributed across multiple processing nodes 1000 and/or distributed across the processing node(s) 1000 and the control system 902.

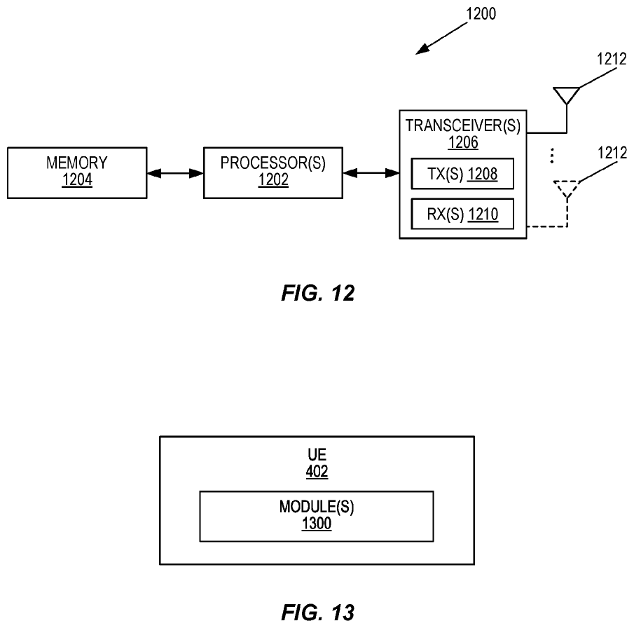

FIG. 12 is a schematic block diagram of a UE 402 according to some embodiments of the present disclosure. As illustrated, the UE 402 includes one or more processors 1202 (e.g., CPUs, ASICs, FPGAs, and/or the like), memory 1204, and one or more transceivers 1206 each including one or more transmitters 1208 and one or more receivers 1210 coupled to one or more antennas 1212. The transceiver(s) 1206 includes radio-front end circuitry connected to the antenna(s) 1212 that is configured to condition signals communicated between the antenna(s) 1212 and the processor(s) 1202, as will be appreciated by on of ordinary skill in the art. The processors 1202 are also referred to herein as processing circuitry. The transceivers 1206 are also referred to herein as radio circuitry. In some embodiments, the functionality of the UE 402 described above may be fully or partially implemented in software that is, e.g., stored in the memory 1204 and executed by the processor(s) 1202. Note that the UE 402 may include additional components not illustrated in FIG. 12 such as, e.g., one or more user interface components (e.g., an input/output interface including a display, buttons, a touch screen, a microphone, a speaker(s), and/or the like and/or any other components for allowing input of information into the UE 402 and/or allowing output of information from the UE 402), a power supply (e.g., a battery and associated power circuitry), etc.

In some embodiments, a computer program including instructions which, when executed by at least one processor, causes the at least one processor to carry out the functionality of the UE 402 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 13 is a schematic block diagram of the UE 402 according to some other embodiments of the present disclosure. The UE 402 includes one or more modules 1300, each of which is implemented in software. The module(s) 1300 provide the functionality of the UE 402 described herein.

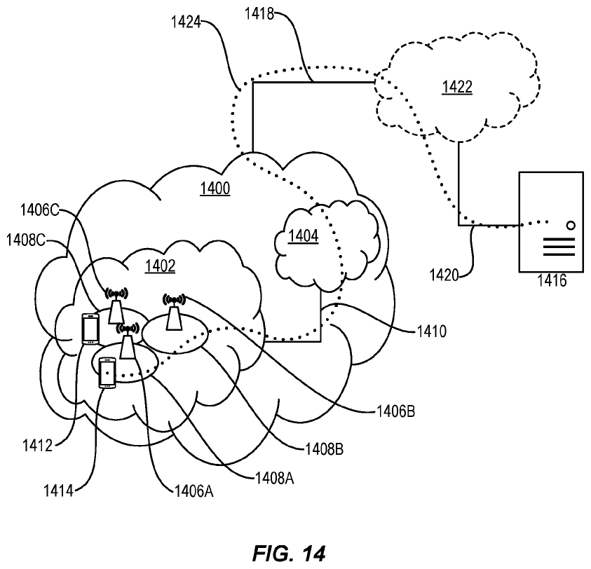

With reference to FIG. 14, in accordance with an embodiment, a communication system includes a telecommunication network 1400, such as a 3GPP-type cellular network, which comprises an access network 1402, such as a RAN, and a core network 1404. The access network 1402 comprises a plurality of base stations 1406A, 1406B, 1406C, such as Node Bs, eNBs, gNBs, or other types of wireless Access Points (APs), each defining a corresponding coverage area 1408A, 1408B, 1408C. Each base station 1406A, 1406B, 1406C is connectable to the core network 1404 over a wired or wireless connection 1410. A first UE 1412 located in coverage area 1408C is configured to wirelessly connect to, or be paged by, the corresponding base station 1406C. A second UE 1414 in coverage area 1408A is wirelessly connectable to the corresponding base station 1406A. While a plurality of UEs 1412, 1414 are illustrated in this example, the disclosed embodiments are equally applicable to a situation where a sole UE is in the coverage area or where a sole UE is connecting to the corresponding base station 1406.

The telecommunication network 1400 is itself connected to a host computer 1416, which may be embodied in the hardware and/or software of a standalone server, a cloud-implemented server, a distributed server, or as processing resources in a server farm. The host computer 1416 may be under the ownership or control of a service provider, or may be operated by the service provider or on behalf of the service provider. Connections 1418 and 1420 between the telecommunication network 1400 and the host computer 1416 may extend directly from the core network 1404 to the host computer 1416 or may go via an optional intermediate network 1422. The intermediate network 1422 may be one of, or a combination of more than one of, a public, private, or hosted network; the intermediate network 1422, if any, may be a backbone network or the Internet; in particular, the intermediate network 1422 may comprise two or more sub-networks (not shown).

The communication system of FIG. 14 as a whole enables connectivity between the connected UEs 1412, 1414 and the host computer 1416. The connectivity may be described as an Over-the-Top (OTT) connection 1424. The host computer 1416 and the connected UEs 1412, 1414 are configured to communicate data and/or signaling via the OTT connection 1424, using the access network 1402, the core network 1404, any intermediate network 1422, and possible further infrastructure (not shown) as intermediaries. The OTT connection 1424 may be transparent in the sense that the participating communication devices through which the OTT connection 1424 passes are unaware of routing of uplink and downlink communications. For example, the base station 1406 may not or need not be informed about the past routing of an incoming downlink communication with data originating from the host computer 1416 to be forwarded (e.g., handed over) to a connected UE 1412. Similarly, the base station 1406 need not be aware of the future routing of an outgoing uplink communication originating from the UE 1412 towards the host computer 1416.

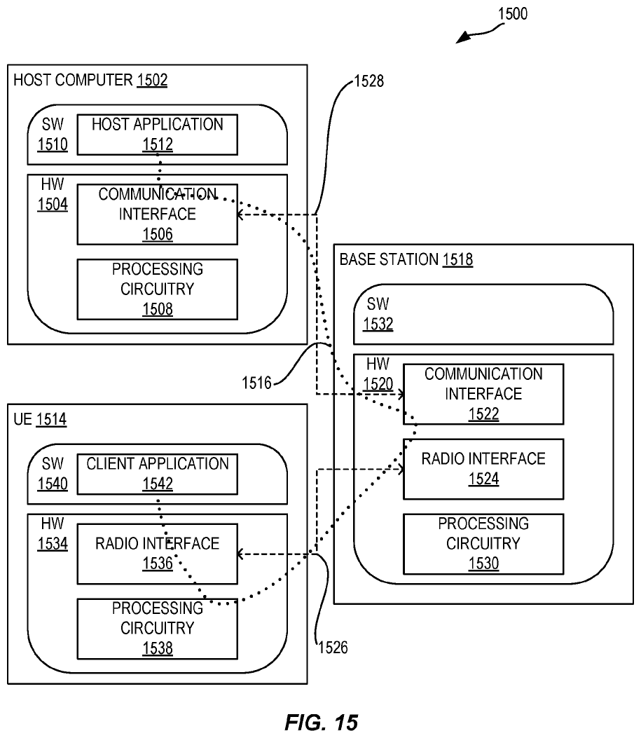

Example implementations, in accordance with an embodiment, of the UE, base station, and host computer discussed in the preceding paragraphs will now be described with reference to FIG. 15. In a communication system 1500, a host computer 1502 comprises hardware 1504 including a communication interface 1506 configured to set up and maintain a wired or wireless connection with an interface of a different communication device of the communication system 1500. The host computer 1502 further comprises processing circuitry 1508, which may have storage and/or processing capabilities. In particular, the processing circuitry 1508 may comprise one or more programmable processors, ASICs, FPGAs, or combinations of these (not shown) adapted to execute instructions. The host computer 1502 further comprises software 1510, which is stored in or accessible by the host computer 1502 and executable by the processing circuitry 1508. The software 1510 includes a host application 1512.

The host application 1512 may be operable to provide a service to a remote user, such as a UF 1514 connecting via an OTT connection 1516 terminating at the UE 1514 and the host computer 1502. In providing the service to the remote user, the host application 1512 may provide user data which is transmitted using the OTT connection 1516.

The communication system 1500 further includes a base station 1518 provided in a telecommunication system and comprising hardware 1520 enabling it to communicate with the host computer 1502 and with the UE 1514. The hardware 1520 may include a communication interface 1522 for setting up and maintaining a wired or wireless connection with an interface of a different communication device of the communication system 1500, as well as a radio interface 1524 for setting up and maintaining at least a wireless connection 1526 with the UE 1514 located in a coverage area (not shown in FIG. 15) served by the base station 1518. The communication interface 1522 may be configured to facilitate a connection 1528 to the host computer 1502. The connection 1528 may be direct or it may pass through a core network (not shown in FIG. 15) of the telecommunication system and/or through one or more intermediate networks outside the telecommunication system. In the embodiment shown, the hardware 1520 of the base station 1518 further includes processing circuitry 1530, which may comprise one or more programmable processors, ASICs, FPGAs, or combinations of these (not shown) adapted to execute instructions. The base station 1518 further has software 1532 stored internally or accessible via an external connection.

The communication system 1500 further includes the UE 1514 already referred to. The UE's 1514 hardware 1534 may include a radio interface 1536 configured to set up and maintain a wireless connection 1526 with a base station serving a coverage area in which the UE 1514 is currently located. The hardware 1534 of the UE 1514 further includes processing circuitry 1538, which may comprise one or more programmable processors, ASICs, FPGAs, or combinations of these (not shown) adapted to execute instructions. The UE 1514 further comprises software 1540, which is stored in or accessible by the UE 1514 and executable by the processing circuitry 1538. The software 1540 includes a client application 1542. The client application 1542 may be operable to provide a service to a human or non-human user via the UE 1514, with the support of the host computer 1502. In the host computer 1502, the executing host application 1512 may communicate with the executing client application 1542 via the OTT connection 1516 terminating at the UE 1514 and the host computer 1502. In providing the service to the user, the client application 1542 may receive request data from the host application 1512 and provide user data in response to the request data. The OTT connection 1516 may transfer both the request data and the user data. The client application 1542 may interact with the user to generate the user data that it provides

It is noted that the host computer 1502, the base station 1518, and the UE 1514 illustrated in FIG. 15 may be similar or identical to the host computer 1416, one of the base stations 1406A, 1406B, 1406C, and one of the UEs 1412, 1414 of FIG. 14, respectively. This is to say, the inner workings of these entities may be as shown in FIG. 15 and independently, the surrounding network topology may be that of FIG. 14.

In FIG. 15, the OTT connection 1516 has been drawn abstractly to illustrate the communication between the host computer 1502 and the UE 1514 via the base station 1518 without explicit reference to any intermediary devices and the precise routing of messages via these devices. The network infrastructure may determine the routing, which may be configured to hide from the UE 1514 or from the service provider operating the host computer 1502, or both. While the OTT connection 1516 is active, the network infrastructure may further take decisions by which it dynamically changes the routing (e.g., on the basis of load balancing consideration or reconfiguration of the network).

The wireless connection 1526 between the UE 1514 and the base station 1518 is in accordance with the teachings of the embodiments described throughout this disclosure. One or more of the various embodiments improve the performance of OTT services provided to the UE 1514 using the OTT connection 1516, in which the wireless connection 1526 forms the last segment.

A measurement procedure may be provided for the purpose of monitoring data rate, latency, and other factors on which the one or more embodiments improve. There may further be an optional network functionality for reconfiguring the OTT connection 1516 between the host computer 1502 and the UE 1514, in response to variations in the measurement results. The measurement procedure and/or the network functionality for reconfiguring the OTT connection 1516 may be implemented in the software 1510 and the hardware 1504 of the host computer 1502 or in the software 1540 and the hardware 1534 of the UE 1514, or both. In some embodiments, sensors (not shown) may be deployed in or in association with communication devices through which the OTT connection 1516 passes; the sensors may participate in the measurement procedure by supplying values of the monitored quantities exemplified above, or supplying values of other physical quantities from which the software 1510, 1540 may compute or estimate the monitored quantities. The reconfiguring of the OTT connection 1516 may include message format, retransmission settings, preferred routing, etc.; the reconfiguring need not affect the base station 1518, and it may be unknown or imperceptible to the base station 1518. Such procedures and functionalities may be known and practiced in the art. In certain embodiments, measurements may involve proprietary UF signaling facilitating the host computer's 1502 measurements of throughput, propagation times, latency, and the like. The measurements may be implemented in that the software 1510 and 1540 causes messages to be transmitted, in particular empty or ‘dummy’ messages, using the OTT connection 1516 while it monitors propagation times, errors, etc.

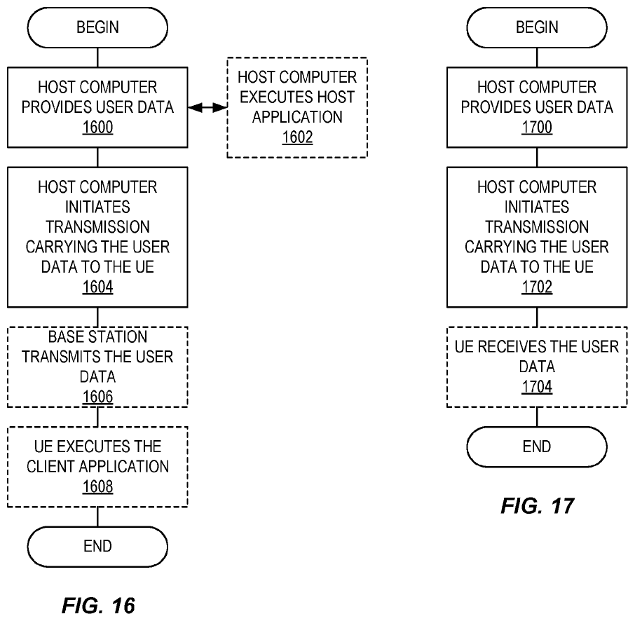

FIG. 16 is a flowchart illustrating a method implemented in a communication system, in accordance with one embodiment. The communication system includes a host computer, a base station, and a UE which may be those described with reference to FIGS. 14 and 15. For simplicity of the present disclosure, only drawing references to FIG. 16 will be included in this section. In step 1600, the host computer provides user data. In sub-step 1602 (which may be optional) of step 1600, the host computer provides the user data by executing a host application. In step 1604, the host computer initiates a transmission carrying the user data to the UE. In step 1606 (which may be optional), the base station transmits to the UE the user data which was carried in the transmission that the host computer initiated, in accordance with the teachings of the embodiments described throughout this disclosure. In step 1608 (which may also be optional), the UE executes a client application associated with the host application executed by the host computer.

FIG. 17 is a flowchart illustrating a method implemented in a communication system, in accordance with one embodiment. The communication system includes a host computer, a base station, and a UE which may be those described with reference to FIGS. 14 and 15. For simplicity of the present disclosure, only drawing references to FIG. 17 will be included in this section. In step 1700 of the method, the host computer provides user data. In an optional sub-step (not shown) the host computer provides the user data by executing a host application. In step 1702, the host computer initiates a transmission carrying the user data to the UE. The transmission may pass via the base station, in accordance with the teachings of the embodiments described throughout this disclosure. In step 1704 (which may be optional), the UE receives the user data carried in the transmission.

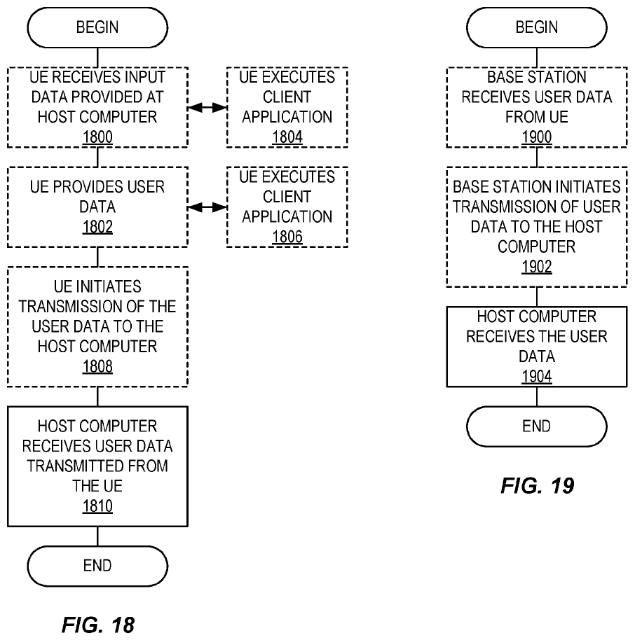

FIG. 18 is a flowchart illustrating a method implemented in a communication system, in accordance with one embodiment. The communication system includes a host computer, a base station, and a UE which may be those described with reference to FIGS. 14 and 15. For simplicity of the present disclosure, only drawing references to FIG. 18 will be included in this section. In step 1800 (which may be optional), the UF receives input data provided by the host computer. Additionally or alternatively, in step 1802, the UE provides user data. In sub-step 1804 (which may be optional) of step 1800, the UE provides the user data by executing a client application. In sub-step 1806 (which may be optional) of step 1802, the UF executes a client application which provides the user data in reaction to the received input data provided by the host computer. In providing the user data, the executed client application may further consider user input received from the user. Regardless of the specific manner in which the user data was provided, the UE initiates, in sub-step 1808 (which may be optional), transmission of the user data to the host computer. In step 1810 of the method, the host computer receives the user data transmitted from the UE, in accordance with the teachings of the embodiments described throughout this disclosure.

FIG. 19 is a flowchart illustrating a method implemented in a communication system, in accordance with one embodiment. The communication system includes a host computer, a base station, and a UE which may be those described with reference to FIGS. 14 and 15. For simplicity of the present disclosure, only drawing references to FIG. 19 will be included in this section. In step 1900 (which may be optional), in accordance with the teachings of the embodiments described throughout this disclosure, the base station receives user data from the UE. In step 1902 (which may be optional), the base station initiates transmission of the received user data to the host computer. In step 1904 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Those skilled in the art will recognize improvements and modifications to the embodiments of the present disclosure. All such improvements and modifications are considered within the scope of the concepts disclosed herein.

1. A method performed by a User Equipment (UE) for acquiring system information of a second cell in a second network using one or more measurement gaps on a first cell in a first network, comprising:
determining candidate system information (SI) positions on the second cell; and
indicating, to a network node, information which identifies the candidate SI positions on the second cell.

2. The method of claim 1 wherein the network node is a network node that controls the first cell in the first network.

3. The method of claim 1 further comprising:
identifying a number (N1) of candidate reference signal (RS) indices, on the second cell in the second network, that meet one or more RS detection conditions;
wherein determining the candidate SI positions on the second cell comprises determining the candidate SI positions on the second cell based on the candidate RS indices.

4. The method of claim 1, wherein the information which identifies the candidate SI positions on the second cell comprises:
information about a preferred number (K1) of measurement gaps on the first cell in the first network, the number (K1) of measurement gaps being associated with the candidate SI positions.

5. The method of claim 1 further comprising receiving, from the network node, information that configures the UE with one or more measurement gaps on the first cell in the first network, in accordance with the information that identifies the candidate SI positions indicated to the network node.

6. The method of claim 5 further comprising acquiring SI for the second cell in the second network using the one or more measurement gaps.

7. The method of claim 3 wherein the one or more RS detection conditions comprise a condition that a received power of a respective RS is greater than a threshold power level.

8. The method of claim 7 wherein the threshold is predefined, network configured, or up to UE implementation.

9. The method of claim 3 wherein the one or more RS detection conditions comprise a condition that a number of RS indices that correspond to a number (M1) strongest RSs as measured at the UE are identified as or comprised in the number (N1) of candidate RS indices.

10. (canceled)

11. The method of claim 3 wherein determining the candidate SI positions on the second cell based on the candidate RS indices comprises determining the candidate SI positions based on positions of Physical Downlink Control Channel (PDCCH) monitoring occasions for SI acquisition on the second cell that map to the candidate RS indices.

12. The method of claim 3 wherein K1 is function of a relation between distance in time among any two candidate SI positions and a threshold.

13. The method of claim 12 wherein K1=N1 if the relation between distance in time among any two candidate SI positions is greater than the threshold and otherwise K1<N1.

14. The method of claim 1 wherein K1=N1.

15-16. (canceled)

17. The method of claim 1 further comprising indicating, to the network node, one or more preferred parameters for the measurement gaps.

18. The method of claim 17 wherein the one or more preferred parameters comprise either or both of a preferred measurement gap length and a preferred measurement gap offset.

19. (canceled)

20. A method performed by a User Equipment (UE) for acquiring system information of a second cell in a second network using one or more measurement gaps on a first cell in a first network, comprising:
identifying information about a number of candidate reference signals (RSs) on a second cell in the second network, that meet one or more RS detection conditions; and
reporting information about the candidate RSs to a network node.

21. The method of claim 20 wherein the network node is a network node that controls the first cell in the first network.

22. (canceled)

23. The method of claim 20 further comprising receiving, from the network node, information that configures the UE with one or more measurement gaps on the first cell in the first network, responsive to reporting the information about candidate RSs.

24. The method of claim 23 further comprising acquiring SI for the second cell in the second network using the one or more measurement gaps.

25. The method of claim 20 wherein the one or more RS detection conditions comprise a condition that a received power of a respective RS is greater than a threshold power level.

26-39. (canceled)
